(19) United States
(12) Patent Application Publication
(10) Pub. No.: US 2002/0134032 A1
(43) Pub. Date: Sep. 26, 2002

(54) #10 shallow mount inside mount

(76) Inventor: Larry S. Gardner, Hoover, AL (US)

Correspondence Address: Robert J. Veal, BURR & FORMAN LLP, Post Office Box 830719, Birmingham, AL, 35283-0719, US

(21) Appl. No.: 09/814,372

(22) Filed: Mar. 20, 2001

(51) Int. Cl. E06B 3/00; E06B 3/30; E06B 1/04; E04C 2/38

(52) U.S. Cl. 52/204.53; 52/211; 52/717.05; 52/717.01

(57) ABSTRACT

This invention relates to the field of extruded polyvinyl foam shutters. More particularly this invention relates to an interior mount frame shutter for tilt-in windows. The present invention addresses the problem in the industry by providing a shallow mount inside mount shutter frame that provides the appearance of an interior mounted shutter but also provides sufficient clearance for tilt-in windows.

### TECHNICAL FIELD

This invention relates to the field of extruded polyvinyl foam shutters. More particularly this invention relates to an interior mount frame shutter for tilt-in windows.

### BACKGROUND OF THE INVENTION

Traditionally, shutters have been made from wood; however, wooden shutters tend to wear out. Wood expands and contracts with the weather resulting in visible signs of wear and tear. As a result of this wear and tear, the dimensions of wooden shutters can change during storage, shipment, or use depending on the environmental conditions.

More recently shutters have been made of extruded polyvinyl materials which have excellent structural rigidity and which do not expand, contract, warp, or absorb liquids. Extruded polyvinyl is a good insulator, nonflammable, and resistant to wear and tear. Polyvinyl can be extruded into a variety of shapes in a process which generates little waste. Because of these properties, the measurements of polyvinyl foam shutters remain constant despite environmental conditions during storage, shipment, or use of the shutters.

A wide variety of shutter assemblies are currently available on the market, but there are some customer desires that the current market has been unable to meet. One example is customers' desire for interior mounted shutters, or shutters that mount inside the existing window casing as opposed to on the adjacent wall. Interior mounted shutters are available on the market; however, a problem arises when the customer also selects the “tilt-in” easy cleaning windows. In order to have an interior mount, the shutter frame must extend inside the window casing, but the shutter frame inside the window casing prevents the window from being tilted far enough for cleaning.

### BRIEF SUMMARY OF THE INVENTION

The present invention addresses the problem in the industry by providing a shallow mount inside mount shutter frame that provides the appearance of an interior mounted shutter but also provides sufficient clearance for tilt-in windows.

In its preferred embodiment, the shallow mount inside mount frame is made of extruded polyvinyl foam. The frame is extruded in two integrally connected sections. The first section extends inside the window casing providing the appearance of an interior mount. This first section acts as a light-stop between the frame and the shutter panel, but is narrow enough to allow the window to tilt-in without contacting the frame; however, it is not of sufficient width to allow for a secure mounting surface. The second section extends outside the edge of the window forming a visible decorative molding. This section is of sufficient thickness that nails, screws, other attachment mechanisms can be securely inserted through the frame to attach the frame to the adjacent wall.

### BRIEF DESCRIPTION OF THE DRAWINGS

FIG. 1 is a sectional view of the interior mount frame;

FIG. 2 is a sectional view of an alternative embodiment of the interior mount frame;

FIG. 3 is a perspective view of the interior mount frame;

FIG. 4 is a perspective view of the interior mount frame in contact with an existing window;

FIG. 5 is a perspective view of the interior mount frame in contact with an existing tilt-in window with the window tilted inwards; and

FIG. 6 is a perspective-sectional view of the interior mount frame with optional pre-drilled mounting holes.

### DETAILED DESCRIPTION OF THE INVENTION

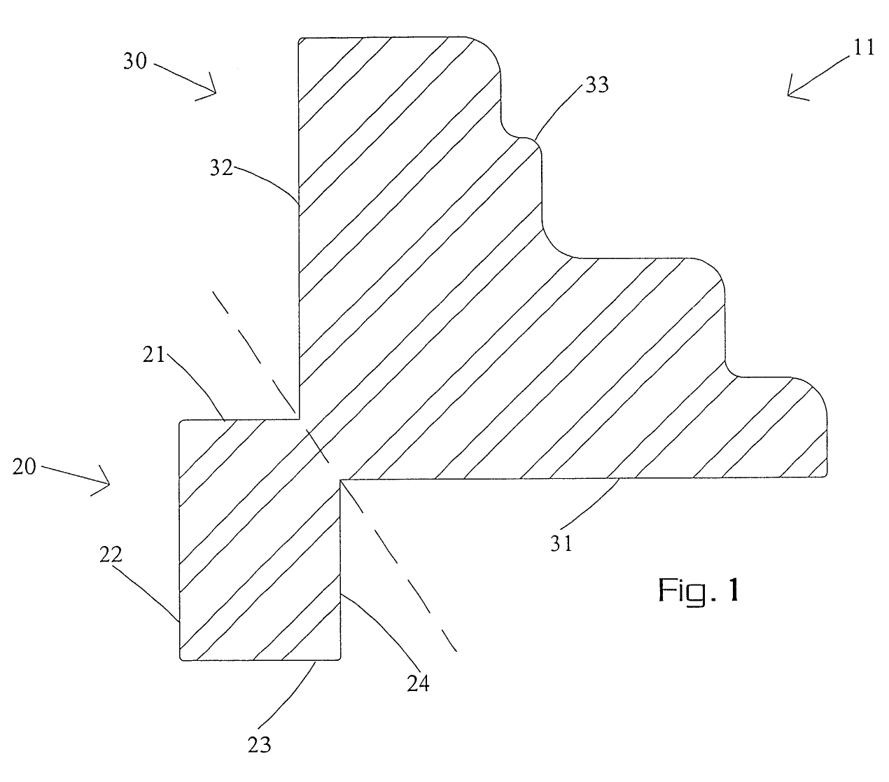

In its preferred embodiment, the interior mounting framing piece (11) is an essentially T shaped, elongated member composed of extruded polyvinyl foam. As illustrated in FIG. 1, there are two primary portions to framing piece (11) which are integrally connected. The first portion is an interior light-stop portion (20) which is placed inside a window to block the light between framing piece (11) and the shutter panel and which creates the appearance of an interior mount. The second portion is a mounting portion (30) which is positioned outside a window casing to allow framing piece (11) to be mounted to an adjacent wall and to create a decorative molding around the shutter panels.

Interior light-stop portion (20) has essentially four sides including a light-stop surface (21), an interior visible surface (22), a rear light-stop surface (23), and an interior mounting surface (24). Light-stop surface (21) is the surface that will be partially visible at all times, even when the shutter panels are closed. Light-stop surface (21) blocks light that would otherwise enter a room between framing piece (11) and the shutter panels.

Light-stop surface (21) in conjunction with interior visible surface (22) creates the appearance of an interior mount. Rear light-stop surface (23) and interior mounting surface (24) are the back two surfaces of interior light-stop portion (20) that are not visible when facing the shutters. On a traditional interior mount shutter, interior visible surface (22) is the surface through which nails or screws would be placed to secure the frame to the window. However, for newer tilt-in windows, interior light-stop portion (20) must be narrow enough to allow for the window to tilt-in, and as a result, the thickness of the polyvinyl extruded foam at that point is not sufficient to allow for a secure attachment of the shutter frame. Wooden shutters have the same problem because wood that is sufficiently narrow to prevent contact with the window sash is not thick enough to allow for a secure attachment of the shutter frame. Therefore, interior light-stop portion (20) serves two purposes: blocking light between the shutter frame and shutter panel and creating the appearance of an interior mounted shutter.

Mounting portion (30) is integrally connected to interior light-stop portion (20); however, it is positioned outside the window casing, flush with the adjacent wall. Mounting portion (30) has a rear mounting surface (31) which contacts the adjacent wall. Shutter mounting surface (32) is the surface to which the shutter panel will be attached and is normal to rear mounting surface (31). A front surface (33) includes decoratively cut levels which provide aesthetic appeal on front surface (33) of mounting portion (30). The mounting mechanisms will pass through front surface (33), through rear mounting surface (31) and into the adjacent wall.

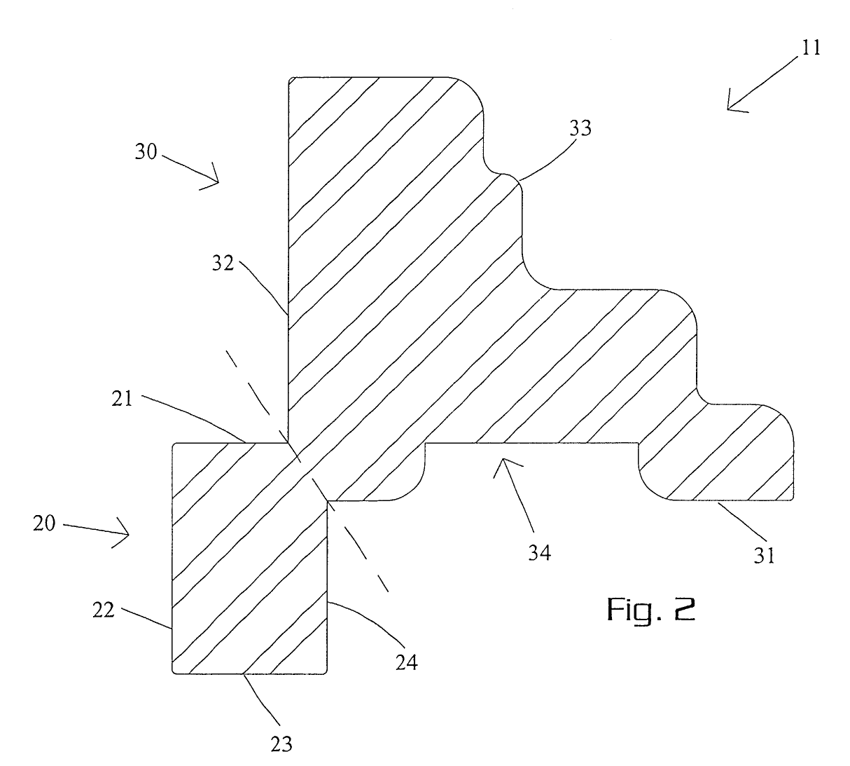

FIG. 2 illustrates the same cross section of framing piece (11); however, it demonstrates an alternative embodiment in which a void (34) is created in rear mounting surface (31). Void (34) is positioned so that there is sufficient surface area on at least one side of void (34) to allow for the framing piece to be appropriately mounted to the adjacent wall. Creation of void (34) allows for a significant materials savings during the extrusion process. In the preferred embodiment, void is—inches wide and—inches deep and saves approximately one foot of material for every twelve feet of frame that are extruded. [amount in cubic feet or inches?]

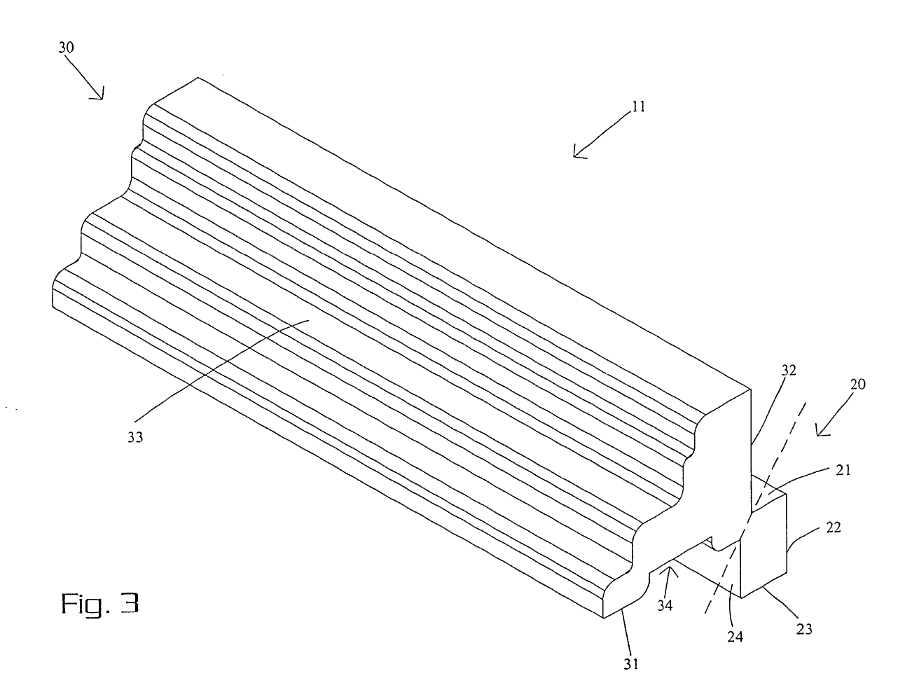

FIG. 3 illustrates framing piece (11) in a dimensional view. The first portion of framing piece (11) is interior light-stop portion (20) which is placed inside a window to block the light between framing piece (11) and the shutter panel and which creates the appearance of an interior mount. The second portion is a mounting portion (30) which is positioned outside a window casing to allow framing piece (11) to be mounted to an adjacent wall and to create a decorative molding around the shutter panels.

Interior light-stop portion (20) includes light-stop surface (21), interior visible surface (22), rear light-stop surface (23) and interior mounting surface (24). Mounting portion (30) is integrally connected to interior light-stop portion (20); however, it is positioned outside the window casing, flush with the adjacent wall. Mounting portion (30) includes rear mounting surface (31), shutter mounting surface (32), and front surface (33).

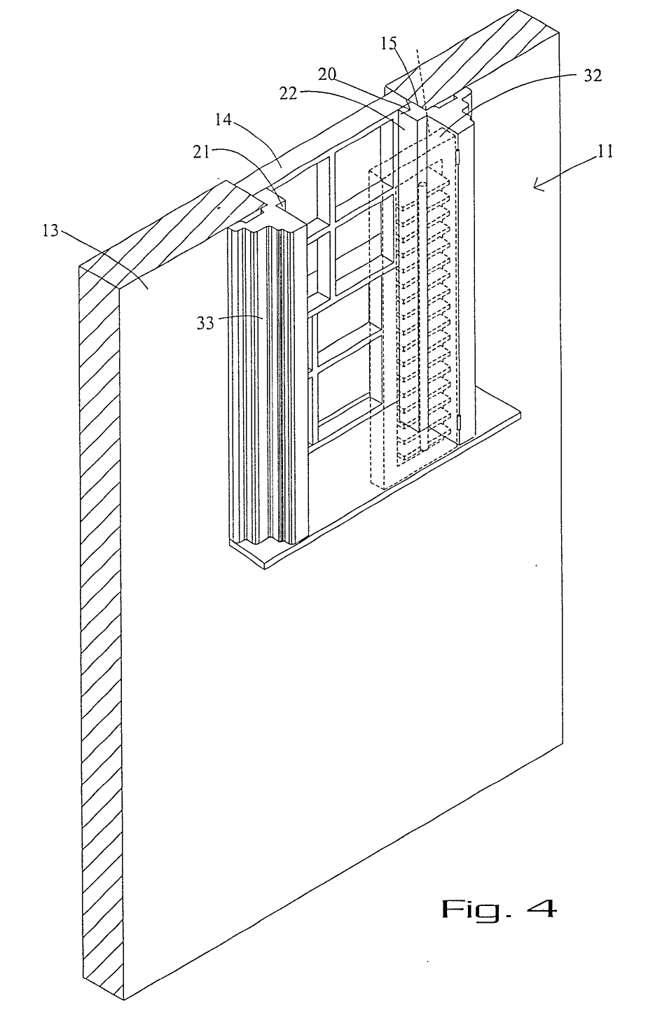

FIG. 4 shows a dimensional view of framing piece (11) in contact with a window casing (15) and an adjacent wall (13). This drawing more clearly illustrates the placement of the various surfaces of framing piece (11) in relation to window casing (15). This figure shows how light-stop surface (21) and interior visible surface (22) combine to create the appearance of an interior mount by extending inward, from shutter mounting surface (32) into window casing (15). Front surface (33) steps down from the outermost edge of shutter mounting surface (32) to the level of adjacent wall (13). Interior light-stop portion (20) does not extend so far into window casing (15) that it prevents a window (14) from tilting inward for cleaning.

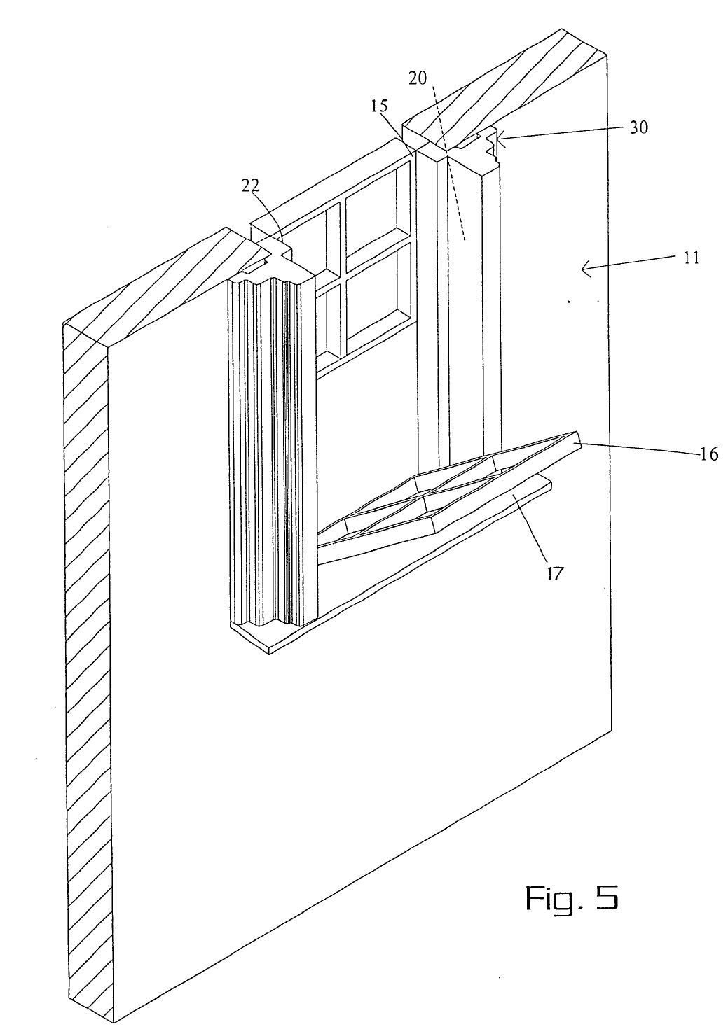

FIG. 5 is a dimensional view of framing piece (11) in contact with window casing (15) and an inwardly tilted window (16). In this figure interior light-stop portion (20) extends inside window casing (15) and mounting portion (30) extends outside window casing (15). Inwardly tilted window (16) is shown to illustrate the clearance between interior visible surface (22) and a window sash (17).

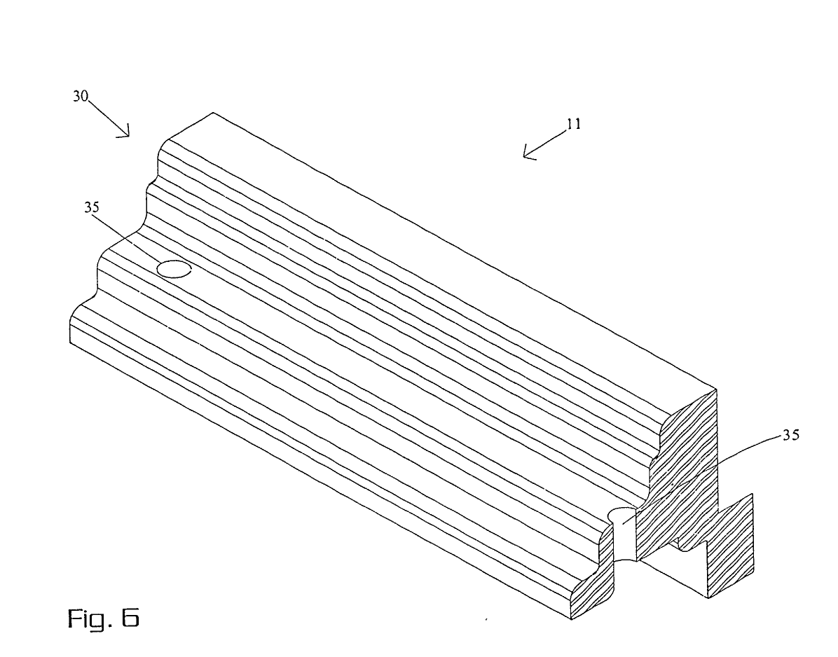

FIG. 6 is a dimensional cross section view of framing piece (11) which illustrates optional pre-drilled mounting holes (35) in mounting portion (30). Pre-drilled mounting holes (35) are a convenience, but are not necessary for installation. Unlike wood, the extruded polyvinyl foam will not split when nails or screws are inserted for mounting purposes. In the preferred embodiment, the frame is mounted with nails inserted by an impulse nail gun.

While this invention has been described in connection with particular examples thereof, it is to be understood that other modifications will become apparent to the skilled practitioner upon a study of the drawings, specification and following claims, and such changes or modifications may be made without departing from the spirit of the invention or scope as defined in the following claims.

What I claim is:

1. An elongated generally T shaped member for framing and mounting shutter panels to a window casing of an adjacent wall, said elongated T shaped member comprising:
a mounting portion and an integrally connected interior light-stop portion;
said mounting portion having a rear mounting surface contacting the adjacent wall, a shutter mounting surface normal to said rear mounting surface, and a front surface essentially parallel to said wall;
said interior light-stop portion having an interior mounting surface contacting the interior of said window casing, a light-stop surface normal to said interior mounting surface and an interior visible surface normal to said light-stop surface and parallel to said interior mounting surface.

2. The elongated T shaped member of claim 1 wherein said elongated T shaped member is extruded polyvinyl foam.

3. The T shaped member of claim 1 in combination with a shutter panel having a vertical margin, said shutter panel hingedly mounted to said channel member in abutting relationship to said shutter mounting surface in a closed position such that said light-stop surface extends horizontally beyond said vertical margin to block light passing between said shutter panel and said shutter mounting surface.

4. The elongated T shaped member of claim 1 in combination with a window including a window portion which tilts about a horizontal axis transverse said window casing wherein said light-stop portion is laterally spaced from said window sufficiently to permit tilting of said window about said axis within said casing without contacting said interior light-stop portion.

5. The elongated T shaped member of claim 1 wherein said light-stop surface and said interior visible surface create the appearance that said shutter panel is mounted inside said window casing.

6. The elongated T shaped member of claim 1 wherein said mounting portion is of sufficient thickness to securely hold an attachment means.

7. The elongated T shaped member of claim 1 wherein said elongated T shaped member is attached to said adjacent wall by attachment means placed through said mounting portion.

8. The elongated T shaped member of claim 7 wherein said attachment means are nails.

9. The elongated T shaped member of claim 7 wherein said attachment means are screws.

10. The elongated T shaped member of claim 1 wherein said mounting portion contains predrilled mounting holes for mounting said elongated T shaped member to said adjacent wall.

11. The elongated T shaped member of claim 10 wherein said elongated T shaped member is attached to said adjacent wall by attachment means placed through said pre-drilled mounting holes in said mounting portion.

12. The elongated T shaped member of claim 11 wherein said attachment means are nails.

13. The elongated T shaped member of claim 11 wherein said attachment means are screws.

14. The elongated T shaped member of claim 1 wherein said rear mounting surface defines an elongated channel facing said adjacent wall.

15. The elongated T shaped member of claim 1 wherein said front surface of said mounting portion comprises a series of interconnected curvilinear shapes providing an aesthetic facade for said elongated T shaped member.

16. A shutter framing piece of a window shutter system in combination with a window, a window sash, a window casing, an adjacent wall, top rails and bottom rails, said shutter framing piece comprising:
an interior light-stop portion, and
an integrally attached mounting portion;
said interior light-stop portion further comprising:
a generally planar interior mounting surface contacting the interior of said window casing,
a generally planar light-stop surface normal to said interior mounting surface, and
a generally planar interior visible surface normal to said light-stop surface and parallel to said interior mounting surface;
said mounting portion further comprising:
a generally planar rear mounting surface contacting said adjacent wall,
a generally planar shutter mounting surface normal to said rear mounting surface, and
a front fascia essentially parallel to said wall.

17. The shutter framing piece of claim 16 wherein said shutter framing piece is extruded polyvinyl foam.

18. The shutter framing piece of claim 16 in combination with a shutter panel having a vertical margin hingedly mounted to said shutter framing piece in abutting relationship to said shutter mounting surface in a closed position such that said light-stop surface extends horizontally beyond said vertical margin to block light passing between said shutter panel and said shutter mounting surface.

19. The shutter framing piece of claim 18 in combination with a window including a window portion which tilts about a horizontal axis transverse said window casing wherein said light-stop portion is laterally spaced from said window sufficiently to permit tilting of said window about said axis within said casing without contacting said interior light-stop portion.

20. The shutter framing piece of claim 16 wherein said light-stop surface and said interior visible surface create the appearance that said shutter panel is mounted inside said window casing.

21. The shutter framing piece of claim 16 wherein said mounting portion is of sufficient thickness to secure an attachment means.

22. The shutter framing piece of claim 16 wherein said shutter framing piece is mounted to said adjacent wall by attachment means placed through said mounting portion.

23. The shutter framing piece of claim 22 wherein said attachment means are nails.

24. The shutter framing piece of claim 22 wherein said attachment means are screws.

25. The shutter framing piece of claim 16 wherein said mounting portion contains pre-drilled mounting holes for mounting said shutter framing piece to said adjacent wall.

26. The shutter framing piece of claim 25 wherein said shutter framing piece is attached to said adjacent wall by attachment means placed through said pre-drilled mounting holes in said mounting portion.

27. The shutter framing piece of claim 26 wherein said attachment means are nails.

28. The shutter framing piece of claim 26 wherein said attachment means are screws.

29. The shutter framing piece of claim 16 wherein said rear mounting surface defines an elongated channel facing said adjacent wall.

30. The shutter framing piece of claim 16 wherein said front fascia of said mounting portion comprises a series of interconnected curvilinear shapes providing an aesthetic facade for said framing piece.
